(19) United States
(12) Patent Application Publication
(10) Pub. No.: US 2022/0048385 A1
(43) Pub. Date: Feb. 17, 2022

(54) THROTTLE CONTROL APPARATUS FOR A VEHICLE AND A MECHANISM THEREOF

(71) Applicant: MAHINDRA & MAHINDRA LIMITED, Mohali (IN)

(72) Inventors: Sunil Mittal, Mohali (IN); Vipin Garg, Mohali (IN)

(21) Appl. No.: 17/275,451

(22) PCT Filed: Sep. 12, 2019
(86) PCT No.: PCT/IN2019/050668

§ 371 Date: Mar. 11, 2021

(30) Foreign Application Priority Data
Sep. 12, 2018 (IN) 201811034484

(51) Int. Cl. B60K 26/02; F02D 11/02; F02D 11/04

(52) U.S. Cl. CPC B60K 26/02; F02D 11/02; B60Y 2200/222; B60K 2026/029; F02D 11/04

(57) ABSTRACT

Throttle control apparatus (810) for a vehicle and a mechanism (800) thereof is provided. A throttle control mechanism (800) includes a first throttle control assembly (802), a second throttle control assembly (804), a first cable (806), a second cable (808), a throttle control apparatus (810), a linkage (812) and a mounting bracket (814). The throttle control apparatus (810) includes a shaft housing (810), a pivot shaft, an intermediate lever (810L) and a lever (810R). The intermediate lever (810L) has a first portion (810Lf) defining a slot (810La) and a second portion (810Ls) defining a slot (810Lb). A first end (806f) of first cable (806) is connected to first throttle control assembly (802) and a second end (806s) of first cable (806) is movably connected to intermediate lever (810L). A first end (808f) of second cable (808) is connected to second throttle control assembly (804) and a second end (808s) of the second cable (808) is movably connected to intermediate lever (810L).

### CROSS REFERENCE TO RELATED APPLICATION

This application is based on and derives the benefit of Indian Application 201811034484 filed on 12 Sep. 2018, the contents of which are incorporated herein by reference.

### TECHNICAL FIELD

The embodiments herein relate to a throttle control mechanism for a vehicle.

### BACKGROUND

Generally, a throttle mechanism of a vehicle is used for regulating a speed and power of an engine by controlling the flow of fuel provided to the engine. Some vehicles have two hand operated throttle controls, one hand operated throttle control is used to vary a speed and power of the engine by varying the flow of fuel provided to the engine, and another hand operated throttle control is used to maintain a fixed speed and power of the engine by maintaining a fixed flow of fuel to the engine. A conventional throttle mechanism which incorporates the aforementioned hand operated throttle controls are subjected to occupy more packaging space and involves more number of components. Providing a compact arrangement and packaging of the components in the aforementioned hand operated throttle mechanism is one of the challenges faced by the original equipment manufacturers (OEM'S).

Therefore, there exists a need for a throttle control mechanism for a vehicle, which obviates the aforementioned drawbacks. Further, there exists a need for a throttle control apparatus, which obviates the aforementioned drawbacks.

### OBJECTS

The principal object of an embodiment of this invention is to provide a throttle control apparatus for a vehicle.

Another object of an embodiment of this invention is to provide a throttle control mechanism for a vehicle.

Another object of an embodiment of this invention is to provide a throttle control apparatus which comprises a common slotted intermediate lever for connecting cables which are connected to corresponding hand operated first throttle control assembly (rotary type throttle control assembly)and second throttle control assembly(fixed type throttle control assembly).

Yet, another object of an embodiment of this invention is to provide a throttle control mechanism for a vehicle, which comprises a first throttle control assembly and a second throttle control assembly that are connected to a common slotted intermediate lever of an throttle control apparatus through corresponding cables, where both hand operated throttle control assemblies work independently.

A further object of an embodiment of this invention is to provide a throttle control mechanism for a vehicle, which consumes less packaging space and involves less number of components.

These and other objects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments of the invention are illustrated in the accompanying drawings, throughout which like reference letters indicate corresponding parts in the various figures. The embodiments herein will be better understood from the following description with reference to the drawings, in which:

FIG. 1 depicts a perspective view of a throttle control mechanism for a vehicle, according to an embodiment of the invention as disclosed herein; and

FIG. 2 depicts a perspective view of a throttle control apparatus, according to an embodiment of the invention as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

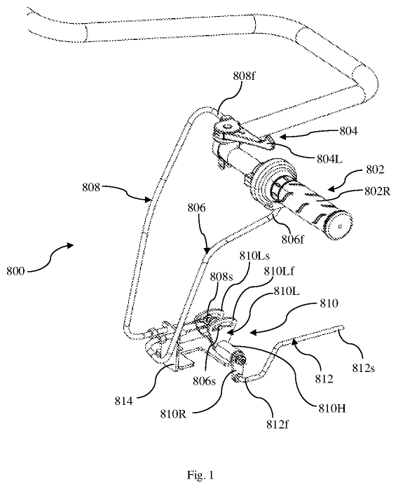

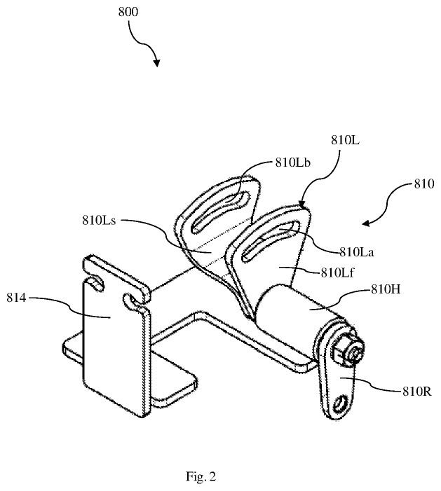

The embodiments herein achieve a throttle control mechanism for a vehicle. Further embodiments herein achieve a throttle control apparatus which comprises a common slotted intermediate lever for connecting cables which are connected to corresponding hand operated first throttle control assembly and second throttle control assembly. Referring now to the drawings, and more particularly to FIGS. 1 through 2, where similar reference characters denote corresponding features consistently throughout the figures, there are shown embodiments.

FIG. 1 depicts a perspective view of a throttle control mechanism 800 for a vehicle, according to an embodiment of the invention as disclosed herein. FIG. 2 depicts a perspective view of a throttle control apparatus 810, according to an embodiment of the invention as disclosed herein. In an embodiment, the throttle control mechanism 800 is used for regulating a speed and power of an engine (not shown) of the vehicle by controlling the flow of fuel provided to the engine. In an embodiment, the throttle control mechanism 800 includes a first throttle control assembly 802, a second throttle control assembly 804, a first cable 806, a second cable 808, a throttle control apparatus 810, at least one linkage 812, a mounting bracket 814 and may include other standard components as present in a standard throttle control mechanism. For the purpose of this description and ease of understanding, the throttle control mechanism 800 is explained herein below with reference to be provided in an agricultural vehicle. However, it is also within the scope of the invention to implement/practice the throttle control mechanism 800 in an off-road vehicle, an agricultural harvester and any other type of vehicle without otherwise deterring the intended function of the throttle control mechanism 800 as can be deduced from the description and corresponding drawings.

The first throttle control assembly 802 is used to vary a speed and power of an engine (not shown) by varying the flow of fuel to the engine. The first throttle control assembly 802 is connected to an intermediate lever 810L (as shown in FIG. 1) of the throttle control apparatus 810 through the first cable 806. The first throttle control assembly 802 is a hand operated rotary throttle control assembly. The first throttle control assembly 802 includes a hand operated rotary throttle control means 802R (as shown in FIG. 1) and may include other standard components as present in a standard hand operated rotary throttle control assembly. However, it is also within the scope of the invention to provide the first throttle control assembly 802 with any other hand operated throttle control means without otherwise deterring the intended function of the first throttle control assembly 802 as can be deduced from the description and corresponding drawings.

The second throttle control assembly 804 is used to maintain a fixed speed and power of the engine by maintaining a fixed flow of fuel to the engine (not shown).The second throttle control assembly 804 is connected to the intermediate lever 810L of the throttle control apparatus 810 through the second cable 808. The second throttle control assembly 804 is a hand operated adjustable throttle control assembly or a hand operated fixed type throttle control assembly. The second throttle control assembly 804 includes a hand operated throttle control means 804L and may include other standard components as present in a standard hand operated adjustable throttle control assembly. The hand operated throttle control means 804L of the second throttle control assembly 804 is configured to be moved and locked at a plurality of positions to maintain the speed of the engine at corresponding fixed rpm. The hand operated throttle control means 804L is at least a hand operated throttle control lever. However, it is also within the scope of the invention to provide the second throttle control assembly 804 with a hand operated throttle control knob or any other hand operated throttle control means without otherwise deterring the intended function of the second throttle control assembly 804 as can be deduced from the description and corresponding drawings.

The first cable 806 connects the first throttle control assembly 802 with the intermediate lever 810L of the throttle control apparatus 810. The first cable 806 is supported by the mounting bracket 814. The first cable 806 has a first end 806f and a second end 806s. The first end 806f of the first cable 806 is connected to the first throttle control assembly 802 and the second end 806s of the first cable 806 is movably connected to a slot 810La (as shown in FIG. 2) defined by a first portion 810Lf (as shown in FIG. 1 and FIG. 2) of the intermediate lever 810L of the throttle control apparatus 810.

The second cable 808 connects the second throttle control assembly 804 with the intermediate lever 810L of the throttle control apparatus 810. The second cable 808 is supported by the mounting bracket 814. The second cable 808 has a first end 808f and a second end 808s.The first end 808f of the second cable 808 is connected to the second throttle control assembly 804 and the second end 808s of the second cable 808 is movably connected to a slot 810Lb (as shown in FIG. 2) defined by a second portion 810Ls(as shown in FIG. 1 and FIG. 2)of the intermediate lever 810L of the throttle control apparatus 810.

In an embodiment, the throttle control apparatus 810 includes an intermediate lever 810L, a pivot shaft (not shown), a shaft housing 810H, a lever 810R, a spring washer (not shown) and a nut (not shown). The intermediate lever 810L is connected to one end of the pivot shaft (not shown) and is also connected to the first throttle control assembly 802 and the second throttle control assembly 804 through the first cable 806 and the second cable 808 respectively. The intermediate lever 810L is also called as pivot shaft lever or throttle linkage lever. In an embodiment, the intermediate lever 810L has a first portion 810Lf and a second portion 810Ls. The first portion 810Lf of the intermediate lever 810L is connected to the second end 806s of the first cable 806. In an embodiment, the first portion 810F of the intermediate lever 810L defines a slot 810La (a shown in FIG. 2), where a portion of the slot 810La is adapted to receive the second end 806s of the first cable 806. The slot 810La is at least one of an elongated slot and an arcuate slot. The second portion 810Ls of the intermediate lever 810L is connected to the second end 808s of the second cable 808. In an embodiment, the second portion 810Ls of the intermediate lever 810L defines a slot 810Lb (as shown in FIG. 2), where a portion of the slot 810Lb is adapted to receive the second end 808s of the second cable 808. The slot 810Lb is at least one of an elongated slot and an arcuate slot. At least a portion of the first portion 810Lf and at least a portion of the second portion 810Ls of the intermediate lever 810L are spaced away from each other.

The pivot shaft (not shown) is movably received inside the shaft housing 810H. One end of the pivot shaft (not shown) is welded to the intermediate lever 810L and another end of the pivot shaft (not shown) is connected to the lever 810R through nut and spring washer (not shown). The shaft housing 810H is used to house the pivot shaft (not shown). The shaft housing 810H is supported by the mounting bracket 814. One end of the lever 810R is connected to the pivot shaft (not shown) and the other end of the lever 810R is connected to the linkage 812.

The linkage 812 has a first end 812f and a second end 812s. The first end 812f of the linkage 812 is connected to the lever 810R and the second end 812s of the linkage 812 is connected to a lever (not shown) of a fuel injection pump (not shown). The linkage 812 is at least a pushrod.

The working of the throttle control mechanism 800 is as follows. When an operator moves the hand operated rotary throttle control means 802R of first throttle control assembly 802 to vary the speed of the engine, the first throttle control assembly 802 pulls the first cable 806 which moves the intermediate lever 810L in an anticlockwise direction and the pivot shaft (not shown) moves the lever 810R in an anti-clockwise direction and the lever 810R in turn pushes the linkage 812 which pushes the lever (not shown) of the fuel injection pump (not shown) to vary the flow of fuel to the engine therein to vary the speed of the engine. The second cable 808 remains in a stationary position on movement of the intermediate lever 810L during operation of the first throttle control assembly 802.

Now, when the operator moves the hand operated adjustable throttle control means 804L of second throttle control assembly 804 to maintain the speed of the engine at a fixed rpm, the second throttle control assembly 804 pulls the second cable 808 which moves the intermediate lever 810L in an anticlockwise direction and the pivot shaft (not shown) moves the lever 810R in an anti-clockwise direction and the lever 810R in turn pushes the linkage 812 which pushes the lever (not shown) of the fuel injection pump (not shown) to maintain fixed flow of fuel to the engine to maintain the speed of the engine at a fixed rpm. The first cable 806 remains in a stationary position on movement of the intermediate lever 810L during operation of the second throttle control assembly 802.

Therefore, a throttle control mechanism 800 for a vehicle is provided.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

We claim:

1. A throttle control apparatus 810 for a vehicle, said apparatus 810 comprising:
a shaft housing 810H;
a pivot shaft adapted to be movably received inside said shaft housing 810H; and
an intermediate lever 810L adapted to be connected to one end of said pivot shaft, wherein
said intermediate lever 810L has a first portion 810Lf defining a slot 810La and a second portion 810Ls defining a slot 810Lb.

2. The apparatus 810 as claimed in claim 1 comprises a lever 810R adapted to be connected to another end of said pivot shaft.

3. The apparatus 810 as claimed in claim 2, wherein a portion of the slot 810La of the first portion 810Lf of said intermediate lever 810L is adapted to receive corresponding end 806s of a first cable 806 of a throttle control mechanism 800 of the vehicle,
where the slot 810La is at least one of an elongated slot and an arcuate slot.

4. The apparatus 810 as claimed in claim 3, wherein a portion of the slot 810Lb of the second portion 810Ls of said intermediate lever 810L is adapted to receive corresponding end 808s of a second cable 808 of the throttle control mechanism 800,
Where the slot 810Lb is at least one of an elongated slot and an arcuate slot.

5. The apparatus 810 as claimed in claim 4, wherein at least a portion of the first portion 810Lf and at least a portion of the second portion 810Ls of said intermediate lever 810L are spaced away from each other.

6. A throttle control mechanism 800 for a vehicle, said mechanism 800 comprising:
a throttle control apparatus 810 comprising a pivot shaft adapted to be movably received inside a shaft housing 810H, an intermediate lever 810L adapted to be connected to corresponding end of said pivot shaft, and a lever 810R adapted to be connected to corresponding another end of said pivot shaft;
a first cable 806 having a first end 806f adapted to be connected to a first throttle control assembly 802 and a second end 806s adapted to be movably connected to said intermediate lever 810L;
a second cable 808 having a first end 808f adapted to be a second throttle control assembly 804 and a second end 808s adapted to be movably connected to said intermediate lever 810L; and
a linkage 812 having a first end 812f adapted to be connected to said lever 810R and a second end 812s adapted to be connected to a fuel injection pump.

7. The mechanism 800 as claimed in claim 6, wherein said intermediate lever 810L has a first portion 810Lf defining a slot 810Fa, where a portion of the slot 810La is adapted to receive the second end 806s of said first cable 806.

8. The mechanism 800 as claimed in claim 7, wherein the slot 810La of the first portion 810Lf of said intermediate lever 810L is at least one of an elongated slot and an arcuate slot.

9. The mechanism 800 as claimed in claim 8, wherein said intermediate lever 810L has a second portion 810Ls defining a slot 810Lb, where a portion of the slot 810Lb is adapted to receive the second end 808s of said second cable 808.

10. The mechanism 800 as claimed in claim 9, wherein the slot 810Lb of the second portion 810Ls of said intermediate lever 810L is at least one of an elongated slot and an arcuate slot.

11. The mechanism 800 as claimed in claim 10, wherein at least a portion of the first portion 810Lf and at least a portion of the second portion 810Ls of said intermediate lever 810L are spaced away from each other.

12. The mechanism 800 as claimed in claim 1 comprises a mounting bracket 814 adapted to support said first cable 806, said second cable 808 and said shaft housing 810H.

13. The mechanism 800 as claimed in claimed in claim 12, wherein said first throttle control assembly 802 comprises,
a hand operated rotary throttle control means 802R adapted to be moved to pull said first cable 806 which moves said intermediate lever 810L and said pivot shaft moves said lever 810R which in turn pushes said linkage 812 which pushes a lever of the fuel injection pump to vary a flow of fuel to an engine therein to vary a speed of an engine.

14. The mechanism 800 as claimed in claim 13, wherein said second cable 808 remains in a stationary position on movement of said intermediate lever 810L during operation of said first throttle control assembly 802.

15. The mechanism 800 as claimed in claim 14, wherein said second throttle control assembly 804 comprises,
a hand operated throttle control means 804L configured to be moved and locked at a plurality of positions to maintain the speed of the engine at corresponding fixed rpm, wherein
said hand operated throttle control means 804L is adapted to be moved to pull said second cable 808 which moves said intermediate lever 810L and said pivot shaft moves said lever 810R which in turn pushes said linkage 812 which pushes the lever of the fuel injection pump to maintain a fixed flow of fuel to the engine therein to maintain the speed of the engine at the fixed rpm.

16. The mechanism 800 as claimed in claim 15, wherein said first cable 806 remains in a stationary position on movement of said intermediate lever 810L during operation of said second throttle control assembly 804.
